(19) United States
(12) Patent Application Publication
(10) Pub. No.: US 2014/0255870 A1
(43) Pub. Date: Sep. 11, 2014

(54) DENTAL AND MEDICAL SUCTION TOOLS

(71) Applicant: Samuel Eakin, Riverside, CA (US)

(72) Inventor: Samuel Eakin, Riverside, CA (US)

(21) Appl. No.: 13/791,883

(22) Filed: Mar. 8, 2013

(51) Int. Cl. A61C 17/06

(52) U.S. Cl. CPC A61C 17/043
USPC 433/95

(57) ABSTRACT

A suction apparatus has a tube. The tube has an end to be inserted in a user's body. The tube has another end for coupling with a vacuum hose to remove air. A check valve coupled is to the tube. The check valve is configured to prevent a back pressure flow into the user's mouth. For an embodiment, the dental suction apparatus includes a base coupled to the tube. Base includes a control valve to control the air removal. For an embodiment, the dental suction apparatus includes a check valve coupler coupled to the tube. For an embodiment, the check valve is on the check valve coupler.

### FIELD

Embodiments as described herein relate to medical and dental tools, and more particularly, to medical and dental suction systems.

### BACKGROUND

Prior art dental suction tools have been used to remove accumulated saliva, and other debris from the mouths of patients. A dental suction tube is inserted into a patient's mouth. The tube is coupled to a hose connected to a vacuum pump. The saliva is typically extracted from the mouth of the patient by an air flow. The air flow is typically created by pumping air out of the mouth via the tube and hose using the vacuum pump.

FIG. 1A shows a side view 100 of a typical prior art dental suction tube 101. Dental suction tube 101 has an end 102 coupled to a vacuum hose (not shown) and an end 103 that is inserted into a patient's mouth. Tube 101 has an orifice 104 for locking into the vacuum hose. Tube 101 is typically disposed of after each patient's use. Saliva and other debris 106 are extracted from the patient's mouth by an air flow 105. The air flow 105 is created by the vacuum pump (not shown) that pumps the air out of the patient's mouth via the vacuum hose. Air flow 105 transports saliva and other debris 106 from the patients mouth to the vacuum hose. The strong suction is typically needed to create the air flow capable of transporting the saliva and other debris. The strong suction can hurt a patient. For example, if during the operation of the device the patient by accident closes her mouth around the tube, the patient's mouth tissue can be sucked into the tube, which can cause pain.

FIG. 1B shows a side view 110 of the typical prior art dental suction tube 101 when the end 103 is blocked. The end 103 is blocked by an object 107. The object 107 can be patient's tongue, cheek tissue, or any other object. When the suction orifice is abruptly and completely blocked, an air flow 108 is created by a back pressure. The back pressure typically has a diminishing sine wave shape, as shown in FIG. 1B. The back pressure flow 108 is in a direction from the vacuum hose towards the mouth. The vacuum hose is typically neither cleaned nor replaced between successive patients. A disadvantage of the prior art dental suction tube is that back pressure flow 108 can cross-contaminate the patient's mouth with bacteria, saliva, blood, and other debris 109 that are already in the vacuum hose.

### SUMMARY

Embodiments of medical and dental suction apparatuses and methods to provide medical and dental suction are described. For an embodiment, the suction apparatus has a tube. The tube has an end to be inserted in a user's (e.g., patient's) body (e.g., a mouth or other part of the body). The tube has another end for coupling with a vacuum hose to remove air. A check valve is coupled to the tube. The check valve is configured to prevent cross-contamination by a back pressure flow into the user's (e.g., patient's) body (e.g., a mouth or other part of the body). For an embodiment, the suction apparatus includes a base coupled to the tube. The base includes a control valve to control vacuum or the air removal (suction). For an embodiment, the suction apparatus includes a check valve coupler coupled to the tube. For an embodiment, the check valve is on the check valve coupler.

Other features and advantages of embodiments will be apparent from the accompanying drawings and from the detailed description that follows below.

### BRIEF DESCRIPTION OF THE DRAWINGS

The present invention is illustrated by way of example and not limitation in the figures of the accompanying drawings, in which like references indicate similar elements, in which:

FIG. 1A shows a side view of a prior art dental suction tube;

FIG. 1B shows a side view of the prior art dental suction tube when the end of the tube is blocked;

FIG. 2A shows a side view of an exemplary embodiment of a suction tube;

FIG. 2B shows a side view of an exemplary embodiment of a suction tube depicted in FIG. 2A having the opening at end obstructed by an object;

FIG. 3A shows a side view of an exemplary embodiment of a suction tube;

FIG. 3B shows a side view of an exemplary embodiment of a suction tube depicted in FIG. 3A having an opening at the end obstructed by an object;

FIG. 4 shows a side view of an exemplary embodiment of a suction system;

FIG. 5A is a side cross-sectional view of an exemplary embodiment of an end of a suction tube;

FIG. 5B is a top cross-sectional view of an exemplary embodiment of an end of a suction tube; and

FIG. 6A shows a side view of an exemplary embodiment of an end of a suction tube to provide a locking mechanism;

FIG. 6B shows a side view of another exemplary embodiment of an end of a suction tube to provide a locking mechanism;

FIG. 7 shows a side view of an exemplary embodiment of a suction system;

FIG. 8 shows a side view of another exemplary embodiment of a suction system;

FIG. 9A shows a side view of another exemplary embodiment of a suction system;

FIG. 9B shows a side view of another exemplary embodiment of a suction system;

FIG. 10 shows a cross-sectional view of another exemplary embodiment of a suction system;

FIG. 11A shows a cross-sectional view of an exemplary embodiment of a disk check valve in a closed state;

FIG. 11B shows cross-sectional views of an exemplary embodiment of a disk check valve in an opened state;

FIG. 12A shows a cross-sectional view of an exemplary embodiment of a ball check valve in a closed state;

FIG. 12B shows a cross-sectional view of an exemplary embodiment of a ball check valve in an opened state;

FIG. 13A shows a cross-sectional view of an exemplary embodiment of a dual plate wafer check valve in a closed state;

FIG. 13B shows a cross-sectional view of an exemplary embodiment of a dual plate wafer check valve in an opened state;

FIG. 14A shows a cross-sectional view of an exemplary embodiment of a wafer check valve in a closed state;

FIG. 14B shows a cross-sectional view of an exemplary embodiment of a wafer check valve in an opened state.

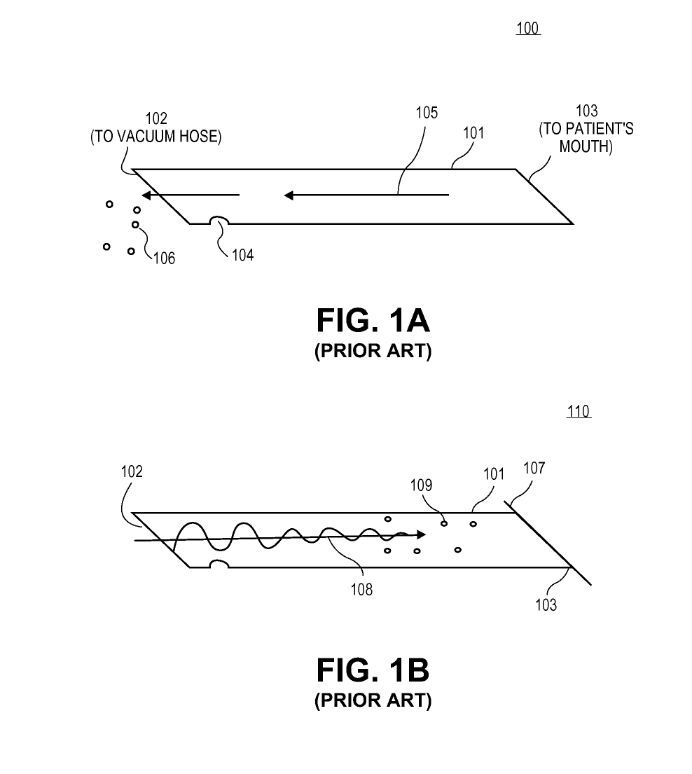

### DETAILED DESCRIPTION

Embodiments of medical and dental suction apparatuses and methods to provide suction are described. The suction apparatus has a tube. The tube has an end to be inserted in a user's (e.g., patient's) body (e.g., a mouth or other part of the body). The tube has another end for coupling with a vacuum hose to remove air. A check valve is coupled to the tube. The check valve is configured to prevent cross-contamination by a back pressure flow into the user's body (e.g., a mouth, or other part of the body). For an embodiment, the suction apparatus includes a base coupled to the tube. The base includes a control valve, or other type of valve to control the vacuum or air removal (suction). For an embodiment, the suction apparatus includes a check valve coupler coupled to the tube. For an embodiment, the check valve is located on the check valve coupler. For one embodiment, the suction apparatus is a dental suction tool, e.g., a saliva extractor. For another embodiment, the suction apparatus is a medical suction apparatus, e.g., a surgical suction tool.

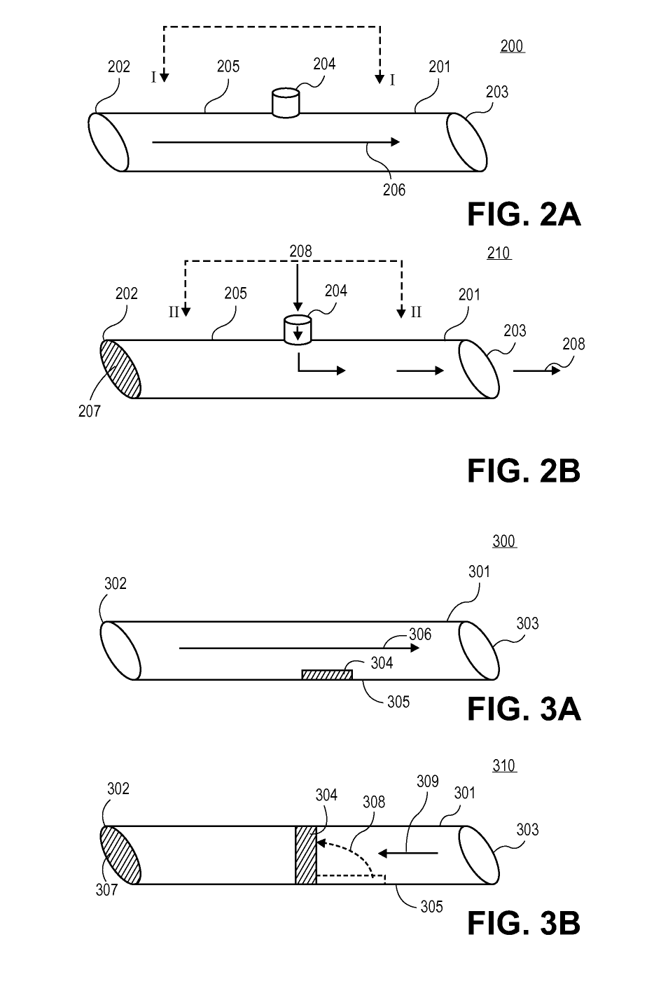

FIG. 2A shows a side view 200 of an exemplary embodiment of a suction tube 201. A suction tube 201 can be one of a dental suction tube and a medical suction tube. Tube 201 has an opening at an end 202 to be inserted in a user's (e.g., patient's) body (e.g., a mouth or other part of the body) and an opening at an end 203 for coupling with a vacuum hose (not shown). A check valve to prevent cross-contamination by a back pressure flow from occurring is located on a wall 205 of the tube 201. Check valve 204 is positioned on the wall 205 outside the patient's body (e.g., a mouth or other part of the body). For one embodiment, the check valve 204 is a spring loaded check valve. For one embodiment, the check valve is a part of the tube.

The air from the body (e.g., a mouth or other part of the body) is removed through the tube 201 and the vacuum hose by a vacuum pump (not shown) that creates an air flow 206. Saliva, blood, other fluids, biological debris, and other matter are removed from the patient's body (e.g., a mouth or other part of the body) by air flow 206. For an embodiment, if the opening at end 202 is not obstructed, check valve 204 is closed.

FIG. 2B shows a side view 210 of an exemplary embodiment of the suction tube depicted in FIG. 2A having the opening at end 202 obstructed by an object 207. An object 207 can be a tongue, cheek, oral tissue, or other body object. As shown in FIG. 2B, check valve 204 is opened to introduce air 208 into tube 201. For an embodiment, a determination is made if a vacuum pressure is greater than a threshold. If the vacuum pressure is greater than the threshold, the check valve 204 is opened to introduce air 208. For an embodiment, the size of the opening in the check valve is from about 0.2 centimeters (“cm”) to about 0.4 cm. For an embodiment, the size of the opening in the check valve is about 0.3 cm (about ⅛ of an inch).

For an embodiment, the opening (orifice) which the spring-loaded check valve uses to inject atmosphere into the saliva extractor is roughly ⅛ (0.125) inches in diameter. The opening size can be increased to allow additional volume of atmosphere to be injected when the spring-loaded check valve actuates. For an embodiment, the spring-loaded check valve opens when there is approximately 5 to 10 inches (of Hg) of vacuum inside the saliva extractor. The pressure at which the check valve opens can be increased or decreased depending on an application.

For example, for the spring loaded check valve, when the opening at the end of the tube is not obstructed, the tension of the spring that keeps the check valve closed is greater than the vacuum pressure. When the patient's mouth is closed around the tube, and the opening at the end of the tube becomes obstructed, the vacuum pressure in the tube becomes greater than the tension of the spring of the check valve, and check valve opens allowing air into the tube. The air introduced into the tube reduces the vacuum pressure that prevents creating the back pressure. Accordingly, there is no a back pressure flow to the patient's mouth. The reduced vacuum pressure causes less strain on patient's oral tissues. For an embodiment, tube 201 has an oval cross-section, so that wall 205 on which check valve 204 is placed is flatter than an adjacent wall. For another embodiment, tube 201 has a circular cross-section.

FIG. 3A shows a side view 300 of an exemplary embodiment of a suction tube 301. A suction tube 301 can be one of a dental suction tube and a medical suction tube. Tube 301 has an opening at an end 302 to be inserted in a patients' body (e.g., a mouth or other part of the body) and an opening at an end 303 for coupling with a vacuum hose (not shown). The air from the body (e.g., a mouth or other part of the body) is removed through the tube 301 and the vacuum hose by a vacuum pump that creates an air flow 306. A check valve 304 to prevent a back pressure flow from entering the body (e.g., a mouth or other part of the body) is located inside the tube 301. For an embodiment, check valve 304 is an in-line check valve. The air from the body (e.g., a mouth or other part of the body) is removed through the tube 301 and the vacuum hose by a vacuum pump (not shown) that creates an air flow 306. Saliva, blood, other fluids, biological debris, and other matter are removed from the patient's body (e.g., a mouth or other part of the body) by air flow 306. For an embodiment, if the opening at end 302 is not obstructed, check valve 304 is in a horizontal position along the wall of the tube 301 allowing the air flow 306 to exit the tube at end 303.

FIG. 3B shows a side view 310 of an exemplary embodiment of the suction tube depicted in FIG. 3A having the opening at end 302 obstructed by an object 307. An object 307 can be a tongue, cheek, any oral tissue, or other body object. As shown in FIG. 3B, check valve 304 is placed in a vertical position 308 relative to the wall of the tube 301 to block the back pressure flow 309. For an embodiment, a determination is made if a vacuum pressure is greater than a threshold. If the vacuum pressure is greater than the threshold, the check valve 304 is placed in the vertical position 308. Check valve 304 blocks the back pressure flow 309 from introducing foreign bacteria, or other matter into the patient's body (e.g., a mouth or other part of the body).

For example, for the in-line check valve, when the opening at the end of the tube is not obstructed, the tension of the spring is greater than the vacuum pressure, and a blocking mechanism of the check valve is kept in a horizontal position by the spring tension. When the opening at the end of the tube becomes obstructed, the vacuum pressure in the tube becomes greater than the tension of the spring of the check valve, and a blocking mechanism of check valve is lifted to a vertical position. Because the air is not introduced into the tube, the vacuum pressure is not reduced, and the back pressure flow can be created. The back pressure flow is physically blocked by the blocking mechanism of the check valve in the vertical position. The design of tube 301 may not prevent stress to oral tissues as well as the design of tube 201. For an embodiment, tube 301 has an oval cross-section, so that wall 305 on which check valve 304 is placed is flatter than an adjacent wall. For an embodiment, tube 201 has a circular cross-section.

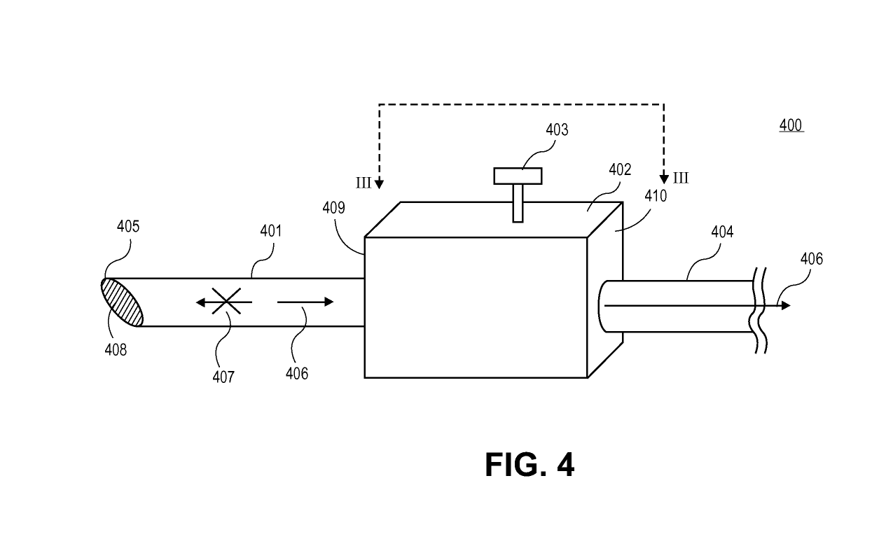

FIG. 4 shows a side view of an exemplary embodiment of a suction system. A suction system 400 can be one of a dental suction system and a medical suction system. A suction system 400 includes a tube 401 having an end 405 to be inserted in a patient's body (e.g., a mouth or other part of the body) and an opposite end connected to a side 409 of a base 402. Base 402 is a receptacle for the suction tube 401. For an embodiment, tube 401 is secured into base 402 by a locking mechanism. For an embodiment, tube 401 has a check valve (not shown). For an embodiment, tube 401 represents one of tubes 201 and 301. For an embodiment, tube 401 is made of a non-toxic medical grade plastic. For an embodiment, tube 401 is made of a non-toxic medical grade polyvinyl chloride (“PVC”), or other non-toxic medical grade plastic material. For an embodiment, tube 401 is made of a non-toxic medical grade metal material (e.g., stainless steel, or other medical grade metal).

Base 402 has a control valve 403 to control vacuum or air removal (suction). For an embodiment, control valve 403 is a gate valve. For other embodiments, control valve 403 is a ball valve, or other type of valve. Base 402 is typically held by a user during use. Base 402 includes a side 410 connected to a vacuum hose 404. The air from the body (e.g., a mouth or other part of the body) is removed through the tube 401, base 402, and the vacuum hose 404 by a vacuum pump (not shown) that creates an air flow 406. Saliva, other fluids, biological debris, and other matter are removed from the patient's body (e.g., a mouth or other part of the body) by air flow 406.When an opening at end 405 is obstructed by an object 408 (e.g., a tongue, cheek, any other oral tissue, or other body object), a back pressure flow 407 is prevented from entering the body by the check valve of the tube 401.

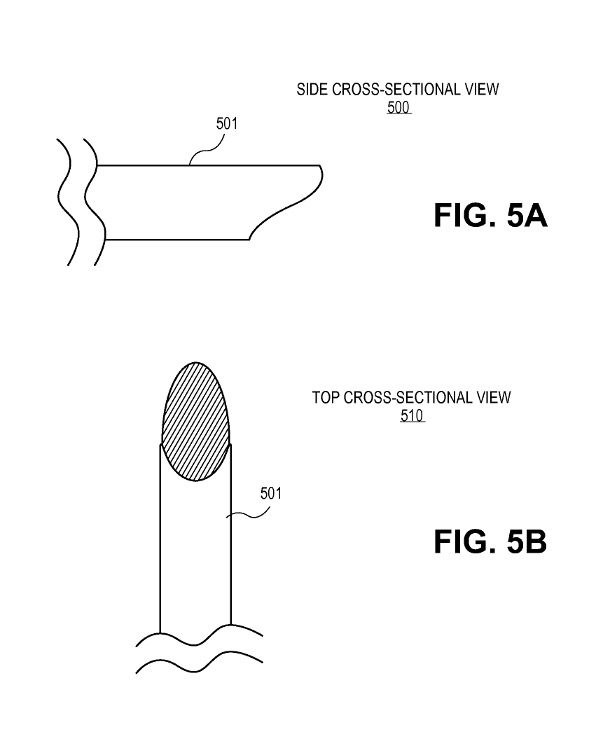

FIG. 5A is a side cross-sectional view 500. FIG. 5B is a top cross-sectional view 510 of an exemplary embodiment of an end of a suction tube 501. Tube 501 can represent one of the tubes 201, 301, and 401. Tube 501 has a beveled or mitered end to direct the vacuum within the patient's mouth. As shown in FIG. 5A, the end of the tube 501 is slanted and smooth. For an embodiment, tube 501 can be identically shaped at both ends to be reversible.

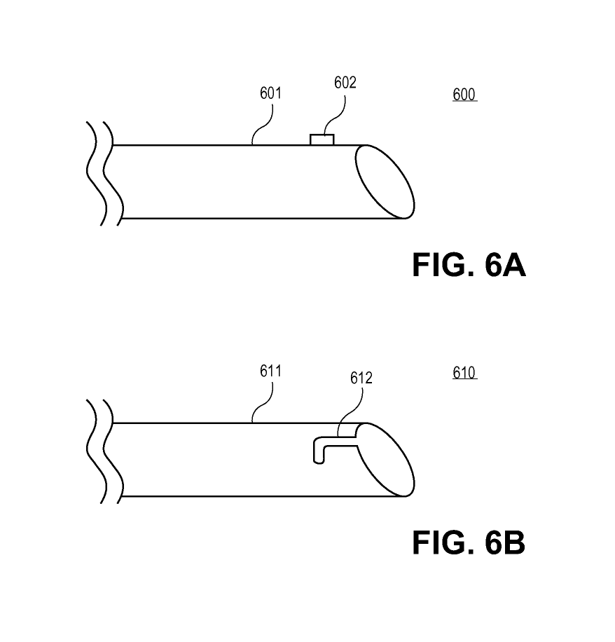

FIG. 6A shows a side view 600 of an exemplary embodiment of an end of a suction tube to provide a locking mechanism. A tube 601 can represent one of the tubes 201, 301, 401, and 501. A male part 602 (e.g., a raised cylindrical protrusion) is placed on the tube 601 and a matching female part (e.g., a groove) is placed on a base, such as base 402 to provide a cam lock. For an embodiment, tube 601 has male part 602 at both ends to be reversible.

FIG. 6B shows a side view 610 of another exemplary embodiment of an end of a suction tube to provide a locking mechanism. A tube 611 can represent one of the tubes 201, 301, 401, and 501. A female part 612 (e.g., a groove) is placed on a tube 611 and a matching male part (e.g., a protrusion) is placed on a base of the suction system, such as base 402 to provide a cam lock. For an embodiment, tube 611 has female part 612 at both ends to be reversible.

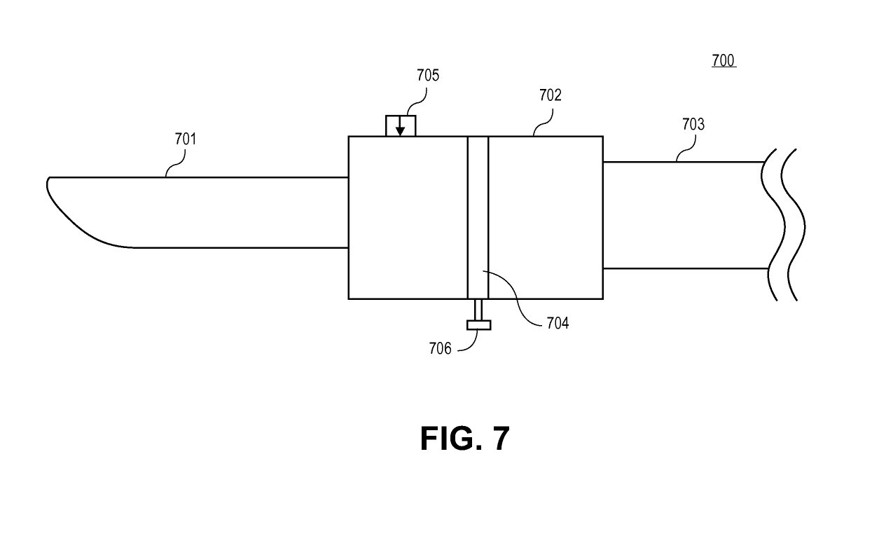

FIG. 7 shows a side view of an exemplary embodiment of a suction system. A suction system 700 can be one of a dental suction system and a medical suction system. Suction system 700 includes a tube 701 having an end to be inserted in a patient's body (e.g., a mouth or other part of the body) and an opposite end connected to a base 702. Base 702 is a receptacle for suction tube 701. Tube 701 can be any type of dental suction tubes currently used by practitioners. For an embodiment, tube 701 is secured into base 702 by a locking mechanism, e.g., a cam lock mechanism, as described above with respect to FIGS. 6A and 6B. Base 702 has a control valve 704 to control vacuum or air removal (suction). Valve 704 has a regulator 706 to adjust strength of the vacuum or air removal (suction) from the patient's body (e.g., a mouth or other part of the body). For an embodiment, valve 704 is a gate valve. For other embodiments, control valve 704 is other type of valve. A check valve 705 is placed on base 702. For an embodiment, check valve 705 is a spring loaded check valve. Base 402 is typically held by a practitioner during use. Base 702 is connected to a vacuum hose 703. The air from the body (e.g., a mouth or other part of the body) is removed through the tube 701, base 702, and the vacuum hose 703 by a vacuum pump (not shown) that creates an air flow. Saliva, blood, other fluids, biological debris, and other matter are removed from the user's body (e.g., a mouth or other part of the body) by the created air flow. If the opening at the body (e.g., a mouth or other part of the body) end of tube 701 is not obstructed, check valve 705 is closed.

When an opening at the end of tube 701 is obstructed by an object (e.g., a tongue, cheek, any other oral tissue, or other body object), check valve 705 opens to allow air into the base 702 that reduces vacuum pressure. A back pressure flow is prevented from entering the body (e.g., a mouth or other part of the body) through the tube 701 by the check valve on the base 702. For an embodiment, check valve 705 opens to introduce air when the vacuum pressure becomes greater than a threshold. Positioning the check valve on the base provides an advantage of being able to use existing dental suction tubes that do not have the check valves on the tubes.

As shown in FIG. 7, check valve 705 is between the side of the base 702 connecting to tube 701 and valve 704. In this system, when valve 704 is closed, the check valve 705 is closed too. Check valve 705 alleviates oral tissue strain and pain, and prevents the back pressure from occurring.

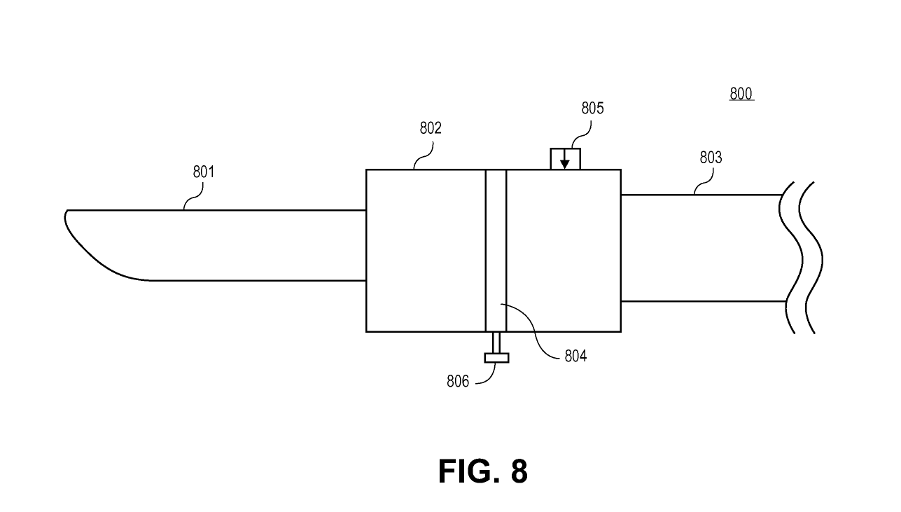

FIG. 8 shows a side view of another exemplary embodiment of a suction system. A suction system 400 can be one of a dental suction system and a medical suction system. A suction system 800 includes a tube 801 having an end to be inserted in a patient's body (e.g., a mouth or other part of the body) and an opposite end connected to a base 802. Base 802 has a valve 804 to control vacuum or air removal (suction). A check valve 805 is placed on base 802. Valve 804 has a regulator 806 to adjust strength of the vacuum or air removal (suction) from the patient's body (e.g., a mouth or other part of the body). Base 802 is connected to a vacuum hose 803. For an embodiment, tube 801, base 802, vacuum hose 803, valve 804, valve 805, and regulator 806 are similar to tube 701, base 702, vacuum hose 703, valve 704, valve 705, and regulator 706, respectively. The system 800 is different from the system 700 in that check valve 805 is placed on base 802 between gate 804 and hose 803. When valve 804 is closed, the check valve 805 remains open and can leak air via hose 803 into the vacuum pumping system.

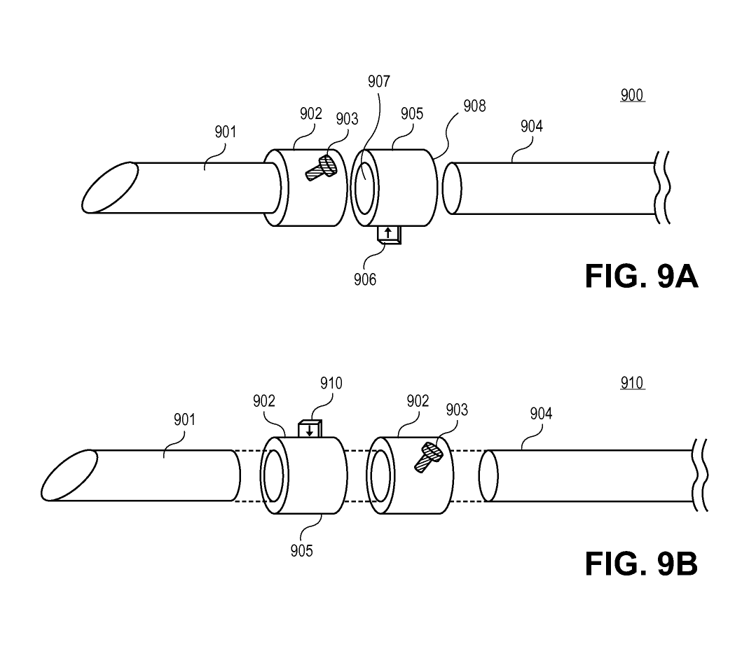

FIG. 9A shows a side view of another exemplary embodiment of a suction system. A suction system 900 can be one of a dental suction system and a medical suction system. A suction system 900 includes a tube 901 having an end to be inserted in a patient's body (e.g., a mouth or other part of the body) and an opposite end connected to a base 902. Base 902 has a control valve 903 to control vacuum or air removal (suction). Valve 903 has a regulator to adjust strength of the vacuum or air removal (suction) from the patient's body (e.g., mouth, or other parts of the body). Base 902 is to be connected to a check valve coupler 905. Check valve coupler 905 has an opening 907 that extends from a side adjacent to base 902 to an opposite side 908 adjacent to a vacuum hose 904. A check valve 906 is placed on a wall of check valve coupler 906. For an embodiment, tube 901, base 902, control valve 903, check valve 906, and vacuum hose 904 represent the corresponding tubes, bases, control and check valves, and vacuum hoses described above. The system 900 is different from the systems described above in that check valve 906 is placed on a separate in-line check valve coupler 905 between base 902 and hose 903. For an embodiment, when valve 903 on base 902 is closed, check valve 906 is opened to allow a small amount of air into the hose 904. This can relieve strain on the vacuum pump motor extending its life.

FIG. 9B shows a side view of another exemplary embodiment of a suction system. A suction system 910 is different from the system 900 in that separate in-line check valve coupler 905 is placed between tube 901 and base 902. For an embodiment, when valve 903 on base 902 is closed, check valve 906 is opened allowing a small amount of air into the hose 904. This can relieve strain on the vacuum pump motor to which the vacuum hose 904 is connected that extends the vacuum pump motor's life. Placing the check valve on a separate check valve coupler allows use of the existing suction tubes and allows retrofitting of other parts of an existing dental suction system.

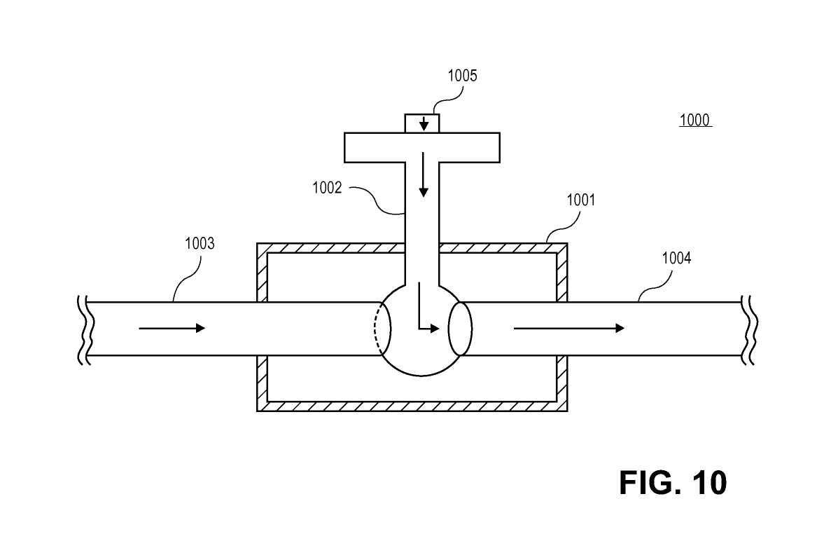

FIG. 10 shows a cross-sectional view of another exemplary embodiment of a suction system. A suction system 1000 can be one of a dental suction system and a medical suction system. Suction system 1000 includes a tube 1003 having an end to be inserted in a patient's body (e.g., a mouth or other part of the body) and an opposite end connected to a base 1001. Base 1001 has a control valve 1002 to control vacuum or air removal (suction). Valve 1002 has a regulator to adjust strength of the vacuum or air removal (suction) from the patient's body (e.g., a mouth or other part of the body). Base 1002 is connected to a vacuum hose 1004. A check valve 1005 to prevent a back pressure flow into the body (e.g., a mouth or other part of the body) via tube 1003 is placed on a control valve 1002. For an embodiment, check valve 1005 is a spring loaded check valve. For an embodiment, tube 1003, base 1001, control valve 1002, vacuum hose 1004, and check valve 1005 represent the corresponding tubes, bases, control valves, vacuum hoses, and check valves described above. The system 1000 is different from the systems described above in that the check valve 1005 is a part of control valve 1002. For an embodiment, control valve 1002 is a gate valve. For an embodiment, control valve 1002 is a ball valve. For an embodiment, control valve 1002 is other type of valve to control vacuum or air removal (suction) from the patient's body (e.g., a mouth or other part of the body).

The air from the body (e.g., a mouth or other part of the body) is removed through the tube 1003, the control valve 1002, and the vacuum hose 1004 by a vacuum pump (not shown) that creates an air flow. Saliva, blood, other fluids, biological debris, and other matter are removed from the patient's body (e.g., a mouth or other part of the body) by the created air flow. If the opening at the body end of tube 1003 is not obstructed, check valve 1005 is closed.

When an opening at the end of tube 1003 is obstructed by an object (e.g., a tongue, cheek, other oral tissue, or other body object), check valve 1005 opens to allow air through the control valve 1002 into the hose 1004 reducing the vacuum pressure. A back pressure flow is prevented from entering the body (e.g., a mouth or other part of the body) through the tube 1003 by the check valve 1005 which is a part of the control valve 1002. For an embodiment, check valve 1005 opens to introduce air into the control valve 1002 when the vacuum pressure becomes greater than a threshold. When the control valve 1002 is closed, the vacuum from the hose 1004 is blocked, the air is not removed from the tube 1003, and the check valve 1005 is closed.

For an embodiment, the check valve as described above has a lock to maintain the check valve in an open position to allow a small amount of air into the suction system when the vacuum pressure is still less than a threshold. This can reduce the vacuum pressure and eliminate possible back pressure in more sensitive patients, for example, elderly.

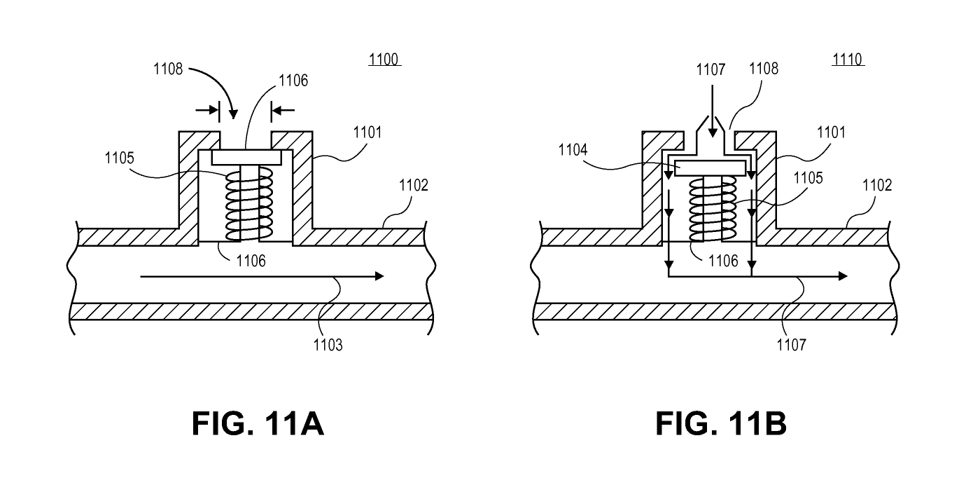

FIGS. 11A and 11B show cross-sectional views of an exemplary embodiment of a disk check valve in a closed state and an opened state, respectively. A disk check valve 1101 has a body 1102. For an embodiment, body 1102 is a part of the suction tube described above. For an embodiment, body 1102 is a part of the base of the suction device described above. For an embodiment, body 1102 is a part of the check valve coupler as described above. For an embodiment, body 1102 is a part of the control valve, as described above. The air 1103 is removed from the patient's body (e.g., a mouth, or other part of the body) via the vacuum hose, as described above. The check valve 1101 has an opening 1108 between top protrusions of the body 1102. A disk 1104 rests against the top protrusions of the body 1102 blocking opening 1108. A spring 105 holds the disk against the top protrusions of the body 1202. Spring 1105 is supported by guides, such as a guide 1106. The vacuum pressure at which the check valve opens can be adjusted by varying tension of the spring 1105. The spring 1105 can be preloaded by moving the guides up/down. This does not require replacing the spring and provides a range of vacuum pressures at which the valve can open. When the vacuum pressure becomes greater than the spring tension (e.g., when the suction tube is obstructed in the patient's body tissue), disk 1104 compresses spring 1105, and air 1107 enters through opening 1108 into body 1102, as shown in FIG. 11B. Introducing air 1107 into body 1102 prevents the back pressure flow into the patient's body (e.g., a mouth or other part of the body), as described above. For an embodiment, the size of the opening 1108 in the check valve is from about 0.2 centimeters to about 0.4 cm. For an embodiment, the size of the opening 1108 in the check valve is about 0.3 cm (about ⅛ of an inch). For an embodiment, the vacuum pressure at which the check valve opens is controlled by varying the size of the opening of the check valve (e.g., opening 1108). For an embodiment, the size of the opening of the check valve is adjusted by using an additional valve (not shown) that is coupled to the opening of the check valve.

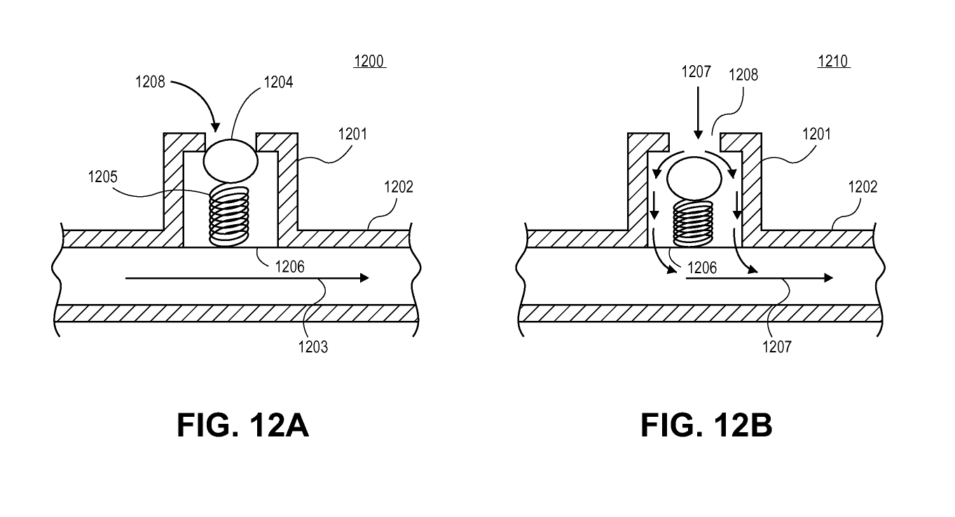

FIGS. 12A and 12B show cross-sectional views of an exemplary embodiment of a ball check valve in a closed state and an opened state respectively. A ball check valve 1201 has a body 1202. For an embodiment, body 1202 is a part of the suction tube described above. For an embodiment, body 1202 is a part of the base of the suction device described above. For an embodiment, body 1202 is a part of the check valve coupler as described above. For an embodiment, body 1202 is a part of the control valve, as described above. The air 1203 is removed from the patient's body (e.g., a mouth or other part of the body) via the vacuum hose, as described above. The ball check valve 1201 has an opening 1208 between top protrusions of the body 1202. A ball 1204 rests against the top protrusions of the body 1202 blocking opening 1208. A spring 1205 holds the ball against the top portions of the body. Spring 1205 is retained by a spring retainer 1206. The vacuum pressure at which the check valve opens can be adjusted by varying tension of the spring 1205. When the vacuum pressure becomes greater than the spring tension (e.g., when the suction tube is obstructed in the patient's body tissue), the ball 1204 on spring 1205 moves down, and air 1207 enters through opening 1208 into body 1202, as shown in FIG. 12B. Introducing the air 1207 into body 1202 prevents the back pressure flow into the patient's body (e.g., mouth, or other parts of the body), as described above. For an embodiment, the size of the opening 1208 in the check valve is from about 0.2 centimeters to about 0.4 cm. For an embodiment, the size of the opening 1207 in the check valve is about 0.3 cm (about ⅛ of an inch). For an embodiment, the vacuum pressure at which the check valve opens is controlled by varying the size of the opening of the check valve (e.g., opening 1207). For an embodiment, the size of the opening of the check valve is adjusted by using an additional valve (not shown) that is coupled to the opening of the check valve.

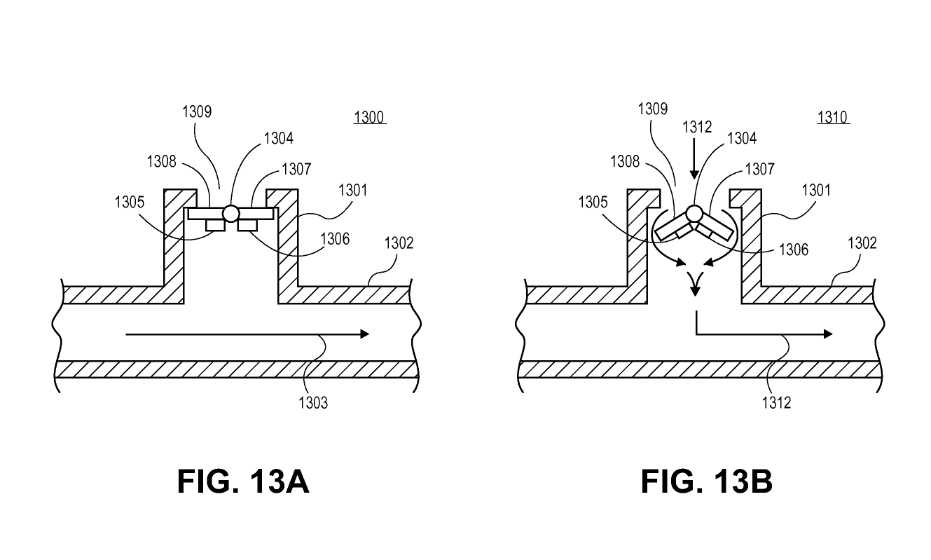

FIGS. 13A and 13B show cross-sectional views of an exemplary embodiment of a dual plate wafer check valve in a closed state and an opened state, respectively. A dual plate wafer check valve 1301 has a body 1302. For an embodiment, body 1302 is a part of the suction tube described above. For an embodiment, body 1302 is a part of the base of the suction device described above. For an embodiment, body 1302 is a part of the check valve coupler as described above. For an embodiment, body 1302 is a part of the control valve, as described above. The air 1303 is removed from the patient's body (e.g., a mouth or other part of the body) via the vacuum hose, as described above. The dual plate wafer check valve 1301 has an opening 1309 between top protrusions of the body 1302. A plate 1307 and a plate 1308 connected via a hinge pin 1304 rest against the top protrusions of the body 1302 blocking opening 1309. A torsion spring 1305 and a torsion spring 1306 hold the corresponding plates 1308 and 1307 against top protrusions of the body. When the vacuum pressure against the plates increases due to the obstruction of the suction tube at the patient's body (e.g., a mouth or other part of the body), the weight of the plates overcomes the resistance of the torsion springs. The plates 1308 and 1307 are moved away from the top protrusions of the body, as shown in FIG. 13B. This introduces outside air 1312 through opening 1309 into body 1302 that prevents the back pressure flow into the patient's body (e.g., a mouth or other part of the body), as described above. For an embodiment, the size of the opening 1309 in the check valve is from about 0.2 centimeters to about 0.4 cm. For an embodiment, the size of the opening 1309 in the check valve is about 0.3 cm (about ⅛ of an inch).

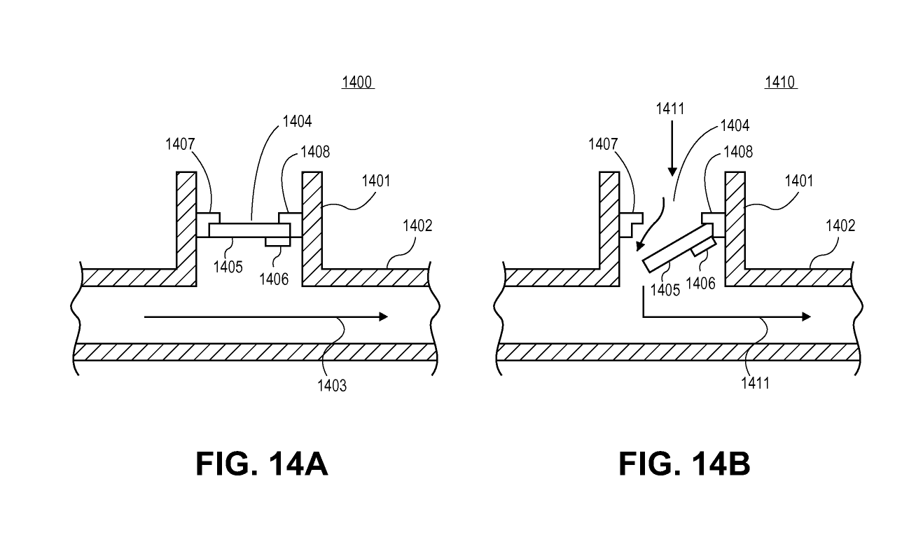

FIGS. 14A and 14B show cross-sectional views of an exemplary embodiment of a wafer check valve in a closed state and an opened state, respectively. A wafer check valve 1401 has a body 1402. For an embodiment, body 1402 is a part of the suction tube described above. For an embodiment, body 1402 is a part of the base of the suction device described above. For an embodiment, body 1402 is a part of the check valve coupler as described above. For an embodiment, body 1402 is a part of the control valve, as described above. The air 1403 is removed from the patient's body (e.g., a mouth or other part of the body) via the vacuum hose, as described above. The wafer check valve 1401 has an opening 1404 between top portions of the body 1402. A diaphragm 1405 rest against the top protrusions 1407 and 1408 of the body 1402 blocking opening 1404. A torsion spring 1406 holds the diaphragm 1405 against the top protrusions of the body 1402. When the vacuum pressure against the diaphragm increases due to the obstruction of the suction tube at the patient's body (e.g., a mouth or other part of the body), the weight of the diaphragm 1405 overcomes resistance of the torsion spring 1405. The diaphragm 1405 moves down from the protrusion 1407, as shown in FIG. 14B. This introduces outside air 1411 through opening 1404 into body 1402 that prevents the back pressure flow into the patient's body (e.g., a mouth or other part of the body), as described above.

For an embodiment, the size of the opening 1404 in the check valve is from about 0.2 centimeters to about 0.4 cm. For an embodiment, the size of the opening 1404 in the check valve is about 0.3 cm (about ⅛ of an inch). For an embodiment, the vacuum pressure at which the check valve opens is controlled by varying the size of the opening of the check valve (e.g., opening 1108). For an embodiment, the size of the opening of the check valve is adjusted by using an additional valve (not shown) that is coupled to the opening of the check valve.

In the foregoing specification, the invention has been described with reference to specific exemplary embodiments thereof. It will, however, be evident that various modifications and changes may be made thereto without departing from the broader spirit and scope of the invention. The specification and drawings are, accordingly, to be regarded in an illustrative rather than a restrictive sense.

1. A suction apparatus comprising:
a tube comprising:
a first end to be inserted into a user's body;
a second end for to couple with a vacuum hose to create an airflow to remove liquids from the user's body; and
a sidewall connecting the first end and the second end of the tube to form a passageway from the first end to the second end;
a check valve extending outwardly from the sidewall and perpendicularly from the passageway, wherein the check valve is configured to automatically create an opening in the sidewall when the first end is obstructed to allow air to move in a direction substantially perpendicular to the airflow to prevent a back pressure flow.

2-3. (canceled)

4. The suction apparatus of claim 1, wherein the check valve is a spring loaded check valve.

5. The suction apparatus of claim 1, further comprising
a base having a control valve to control the flow, a first side coupled to the second end of the tube and a second side to couple to the vacuum hose, wherein the sidewall is a part of the base.

6. The suction apparatus of claim 1, further comprising
a check valve coupler coupled to the tube, wherein the sidewall is a part of the the check valve coupler.

7. A dental suction system, comprising:
a tube comprising a first end to be inserted in a user's body, and a second end;
a base comprising a first side coupled to the second end of the tube, and a second side to couple with a vacuum hose to create an airflow to remove liquids from the user's body;
a sidewall connecting the first side and the second side of the tube to form a passageway from the first end to the second end;
a control valve to control the airflow; and
a check valve extending outwardly from the side wall and perpendicularly from the passageway, wherein the check valve is configured to automatically create an opening in the sidewall when the first end is obstructed to allow air to move in a direction substantially perpendicular to the airflow to prevent a back pressure flow.

8. The dental suction system of claim 7, wherein the check valve is located at the first side of the base.

9. The dental suction system of claim 7, wherein the check valve is located at the second side of the base.

10. The dental suction system of claim 7, wherein the check valve is a part of the control valve.

11. The dental suction system of claim 7, further comprising
a check valve coupler having a first opening, a second opening, wherein the sidewall is a part of the check valve coupler, wherein the first opening is adjacent to the second end of the tube and the second opening is adjacent to the first side of the base.

12. The dental suction system of claim 7, further comprising
a check valve coupler having a first opening, a second opening, wherein the sidewall is a part of the check valve coupler, wherein the first opening is adjacent to the second side of the base, and the second opening for coupling to the vacuum hose.

13-14. (canceled)

15. A method to provide a suction, comprising:
creating an airflow through a tube comprising a first end inserted in a user's body, a second end coupled to a vacuum hose, a sidewall connecting the first end and the second end of the tube to form a passageway from the first end to the second end and a check valve extending outwardly from the sidewall and perpendicularly from the passageway; and
preventing a back pressure flow to the user's body by automatically creating an opening in the sidewall using the check valve when the first end is obstructed.

16. The method of claim 15, wherein the
opening in the sidewall introduces air in a direction substantially perpendicular to the airflow, if the first end of the tube is obstructed.

17. (canceled)

18. The method of claim 15, further comprising
determining if a vacuum pressure is greater than a threshold.

19. The method of claim 15, wherein the check valve is a spring loaded check valve.

20. (canceled)

21. The method of claim 15, further comprising
controlling the air airflow by a control valve coupled to the check valve.

22. The method of claim 15, wherein the check valve is on a coupler between the tube and the vacuum hose, the coupler being a part of the sidewall.
